(19) United States
(12) Patent Application Publication
(10) Pub. No.: US 2014/0289078 A1
(43) Pub. Date: Sep. 25, 2014

(54) System and Method for Automatic Person-To-Person Vehicle Matching

(71) Applicant: Mark O. PAUL, Portland, OR (US)

(72) Inventor: Mark O. PAUL, Portland, OR (US)

(21) Appl. No.: 13/847,475

(22) Filed: Mar. 19, 2013

(51) Int. Cl. G06Q 30/06

(52) U.S. Cl. CPC G06Q 30/0623
USPC 705/26.61

(57) ABSTRACT

Computer-assisted and location-aware sales and marketing systems help buyers and sellers of vehicles find each other when one has (and the other wants) a particular type of vehicle, and when they are in geographic proximity to each other. Extensions of the system allow agents (friends, acquaintances, employees) of the principals to increase the geographic range over which a sales match may be made. Other operational features and modes are also described and claimed.

### CONTINUITY AND CLAIM OF PRIORITY

This is an original U.S. patent application that claims priority to U.S. provisional application No. 61/635,365, filed 19 Apr. 2012.

### FIELD

The invention relates to automated electronic financial or business practice arrangement. More specifically, the invention relates to a computerized arrangement which enables buyers and sellers to investigate, locate, specify, requisition, order, or purchase a vehicle using a device configured to include telecommunications functionality for the exchange of information concerning the vehicle.

### BACKGROUND

Individuals engage in a wide variety of commercial transactions, and transactions where at least one party is an individual make up a large fraction of overall economic activity. However, technological, economic and social pressures have a profound effect on the types of transactions individuals participate in, and the types that occur relatively less often. For example, it used to be common for individuals to hire a repairperson to fix small appliances and household devices, but increasing device complexity and falling prices have made it more common to simply discard broken items and replace them with newly-manufactured ones.

Similar shifts have occurred in the purchase and sale of used items: person-to-person (and in-person) sales have lost ground to long-distance sales and dealer-mediated transactions. This has benefits and drawbacks for individuals: a buyer may have an easier time finding something he wants from an individual seller in another state, or from a dealer that aggregates a lot of trade in items of that type; but an individual seller may have to expend an unreasonable amount of effort to sell any particular item—it may be more difficult for her to manage the marketing, sale and delivery of the item, since she does not have the resources or experience to do much more than hand the item directly over to a buyer in an in-person sale. This asymmetry makes it easier for a buyer to find someone who has what he wants, than for a seller to find a buyer who wants what she has. However, it also strengthens the hand of a dealer, who may be able to purchase the seller's item at a reduced price because he is better-equipped to find a buyer and complete a transaction efficiently. It may also ultimately harm the buyer, if he finds that his desired item is only available from a dealer whose motivation is to “buy low and sell high,” rather than from an individual seller whose desire is to complete a transaction quickly and fairly.

One marketplace where this “dealer tax” can be significant is the sale and purchase of used vehicles. Some individuals appreciate the benefits a dealer can provide in a transaction (e.g., financing, insurance, warranty and other repairs and maintenance to ensure the vehicle is in good working order), but others may prefer to split the difference in price (with the seller receiving more than a dealer would pay, and the buyer paying less than the dealer would charge). A system that can help bring such buyers and sellers together may be of significant value to its users.

### SUMMARY

Systems implementing embodiments of the invention leverage portable computation and communication capabilities, geolocation services and social networks to automate the vehicle-matching process and to increase the chances that a (potential) buyer who is interested in a certain type of vehicle, and a seller who has such a vehicle, will automatically become aware of each other and have an opportunity to complete a transaction. The inventive system can extend (or be extended by) conventional matching support features so that the combination is unequivocally better than traditional offerings.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows operations of an embodiment from a seller's perspective.

FIG. 2 shows operations of an embodiment from a buyer's perspective.

FIG. 3 shows operations of an embodiment from a service-provider's perspective.

FIG. 4 shows some of the individuals, devices and interactions among participants in an embodiment.

FIG. 5 illustrates how an embodiment extends matching range through excursions of a friend or acquaintance of one of the principals.

FIG. 6 outlines some post-transaction activities that can be performed by an embodiment.

### DETAILED DESCRIPTION

The average time it takes buyers to find and purchase a new (to them) vehicle, once they've made a buying decision, is about 3 days. Once a seller has decided to sell their vehicle, the average time from decision to actual sale is much longer, about 60 days. Often sellers prefer to avoid the hassle of trying to sell their vehicle by simply trading it in. However, some sellers may be willing to ‘list’ their vehicles in a way that allows dealers to access their ‘inventory’—when and if a buyer is found, thereby creating a more-desirable transaction, where the dealer may actually pay more because they have a ready-buyer for the seller's vehicle. In this case, for those people who normally prefer to not trade-in their vehicle, sellers may be persuaded to sell to a dealer to both sell faster and for a higher price.

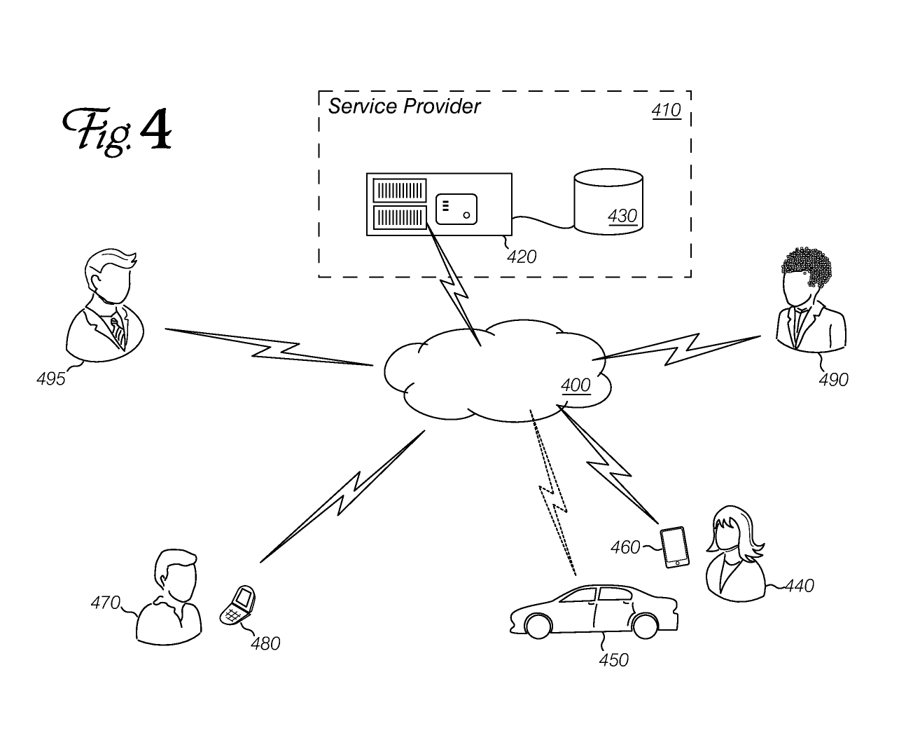

FIG. 4 shows an overview of an environment where an embodiment of the invention operates. The system relies on distributed computational resources, data collection and communication links among participating individuals and their mobile devices, with storage and coordination from a central server. The following descriptions will generally be couched in terms of implementations on common contemporary devices and available services such as cell phones, smartphones, tablets and other personal-computing/networking devices, embedded or stand-alone GPS receivers and Internet data communication. For ease of understanding, only a single buyer/seller transaction will be discussed in detail, but the methods of an embodiment are most valuable when working in a many-to-many context: helping to connect appropriate buyers from a plurality of buyers, each to one or more appropriate sellers from a plurality of sellers and vice versa, so that each buyer learns of sellers who have what he wants, and so that each seller learns of buyers who want what she has, often through the incidental activities and travels of the buyers, sellers, and friends of each.

A central element of the environment is a distributed data communication network 400. The Internet can fill this role in many embodiments, but all that is essential is that the various parties and their computing resources can communicate somehow. Some messages may, for example, be carried by telephone or Small Message Service (“SMS”) messaging, rather than by TCP/IP packets over the Internet. A service provider 410 operates a computer 420 and data storage 430 to facilitate interactions among buyers, sellers and other participants. A seller 440 has a vehicle 450 that she would like to sell; her interactions with the system may be performed through her cell phone 460. A buyer 470 is seeking a vehicle like 450, and engages in the methods of an embodiment via his cell phone 480. In addition, a friend of the seller 490 and/or a friend of the buyer 495 may participate in some portions of the methods. In some implementations, vehicle 450 may comprise geolocation, computing and/or communication resources, which can be used as discussed below. For example, vehicles equipped with the commercial OnStar® system can also participate.

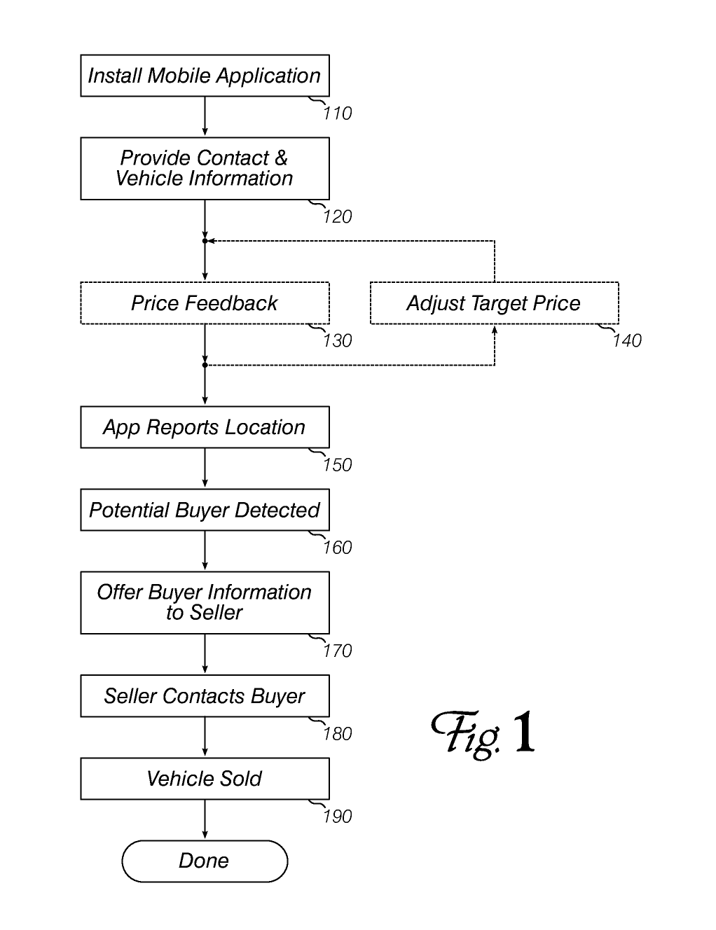

FIG. 1 is a flow chart outlining operations of an embodiment, with emphasis on the seller's perspective. First, the seller installs a mobile phone application (“app”) (110). (An “app” comprises instructions and data to cause a programmable processor of the mobile device to perform various actions as part of the operation of the embodiment, and can be transmitted from the service provider to the mobile device by well-known communication channels.) Other portions of the method (e.g., the seller's actions, and interactions with other parts of the system) can be performed by the same app, or by other separate devices. It is appreciated that many participant activities can be performed on other computers, or even manually, by speaking with a customer service representative who performs the required data entry. However, in a preferred embodiment, the mobile-phone app provides an excellent locus for control, interface and coordination.

Using the app, the seller registers to use the system (120), providing information about herself (e.g., name, address, contact information) and about the vehicle she hopes to sell (e.g., year, make, model and style or “trim;” mileage and condition). Many embodiments can benefit from the entry of the seller's profile or contact information on social-networking services such as the LinkedIn® professional networking service, the Facebook service or the Google Plus service. An important item of information to be collected is the price (or price range) the seller hopes to realize in a sale.

An embodiment may provide feedback about the price in view of historical information available about recent sales of similar vehicles (130), and the seller may adjust her target price accordingly (140). In some embodiments, a suggested target price or price range may be displayed based on the vehicle information, before the seller decides what her target should be.

The mobile app may be used to alter the seller's information (e.g., to change contact information or target price), but it also periodically reports the seller's location to the service provider (150).

From time to time, the system may determine that one or more other users would be suitable buyers for the seller's vehicle (160), so it may contact the seller to offer information about these buyers (170). In some embodiments, the seller will have paid an enrollment fee during registration or when listing a (or an additional) vehicle, while in others, the service provider may withhold some information about the buyer(s) until the seller agrees to pay a broker or finder's fee. The seller may choose to contact the buyer (180), either directly or through the embodiment, and if she eventually meets an interested buyer and they are able to agree on a suitable price, she will be able to sell her vehicle (190).

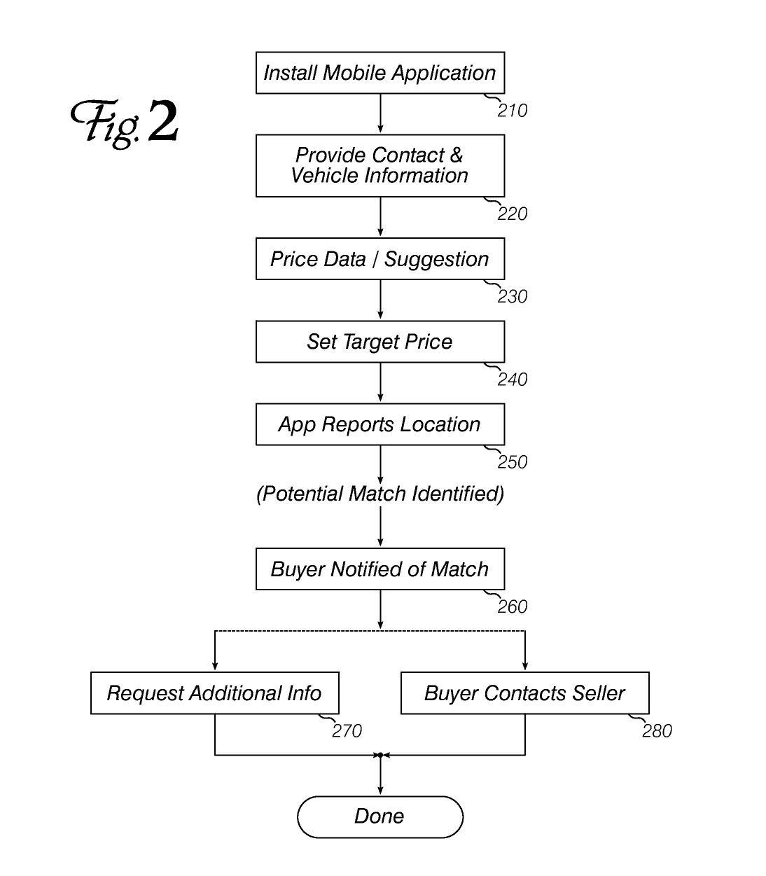

FIG. 2 shows the operations of an embodiment from a buyer's perspective. Like the seller, the buyer may install a mobile-device application (“app”) to facilitate the buyer's interactions with the system (210). The buyer registers to use the system (220) by providing an identifying name, contact information (perhaps including social-media information), and information about a vehicle or vehicle type that he is interested in. The system may suggest a price range at which such vehicles have sold in the past or prices for currently for-sale vehicles (230), and the buyer specifies a target price or price range (240).

A buyer who wants a vehicle of a specific year, make, model and style (or “trim”) may enter that information explicitly, but many buyers are only looking for a vehicle that is suitable for some particular use. Thus, an embodiment may collect non-(year, make, model, style) information from a buyer. For the purposes of this patent application, such information will be referred to a “use-match.” For example, the buyer may be asked about his driving style (e.g., “commuting,” “everyday driving,” “family travel,” “heavy lifting”, “multi-purpose”, “long-distance traveling”, “trade work”, “specialty vehicle” or “sports”); his preference for domestic or foreign manufacture; desired fuel efficiency; towing capacity; or other characteristics. When such use-match characteristics are given, the service provider can compare the year, make, model and style of vehicles for sale to the use-match characteristics and gauge how well each vehicle would satisfy the use-match. Vehicles that match well enough may be identified to the buyer, despite being of a variety of different years, makes, models or styles. For example, a buyer who wants a “family travel” vehicle may be notified of minivans and four-door sedans for sale. A buyer who wants a “commuting” vehicle may be notified of small, high-fuel-efficient vehicles. A buyer who wants a “trade work” vehicle may be notified of larger vehicles with more carrying capacity.

The mobile-device app may accept updated information about the buyer or provide current status reports, but it also periodically reports the buyer's geographic location to the service provider (250). These reports (among other events) may trigger processing at the service provider, which may result in the identification of one or more sellers in the buyer's vicinity who have a vehicle that the buyer may find interesting. When such a match is identified, the service provider may send a notification to the buyer (260), and the buyer may choose to request further information about the seller's vehicle (270) or to contact the seller directly (280).

In addition to buyers and sellers, embodiments of the invention can engage members of the social networks of the principals—their friends, associates, acquaintances, relatives and employees. For example, once a buyer or seller has registered with the system, he may ask his friends to participate by loading an app onto their mobile devices. The app reports the friend's location to the service provider, where it can be correlated with the vehicle for sale (or the desired vehicle) of the reporter's friend. Then, as outlined below, the friend's location can be considered to extend the principal's range or zone of interest, so that a match might be detected even though the buyer and seller are too far apart to trigger a match on their own.

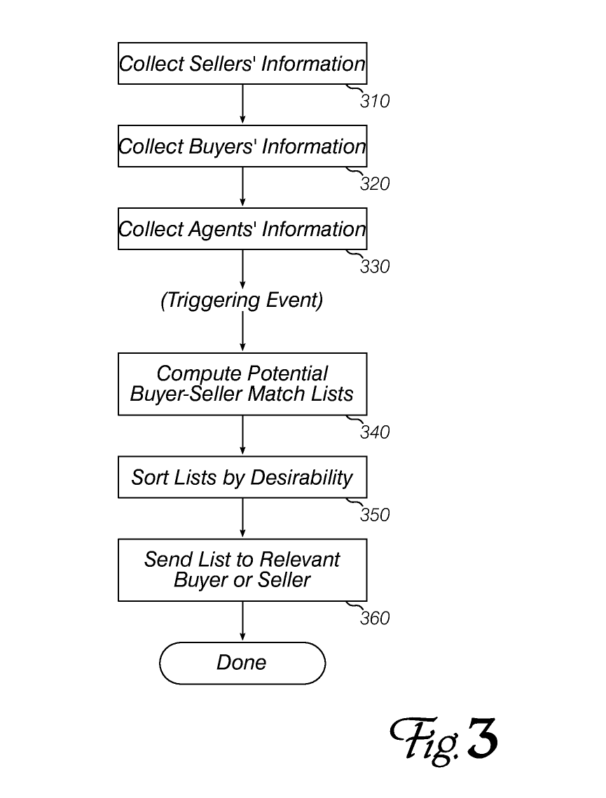

FIG. 3 shows operations from the service provider's perspective. Seller and vehicle-for-sale information are collected from a plurality of sellers (310). Buyer and desired-vehicle information are collected from a plurality of buyers (320). From time to time, information about an agent¹ of a registered buyer or seller may also be received (330). Then, upon a triggering event (described below), the vehicle-for-sale and desired-vehicle information databases are compared to produce a list of potential matches (340), where the list is relevant to one of the sellers or one of the buyers. (In other words, the list of potential matches may be a list of vehicles that may be of interest to a particular buyer; or a list of buyers who may be interested in the vehicle offered by a seller.)

¹ “Agent” in the sense of “friend,” “acquaintance,” “employee” or the like; not in the strict legal sense of “agent and principal.”

The list of matches is sorted by expected desirability (350) and then transmitted to the buyer or seller to whom the list is relevant (360). As discussed below, a triggering event may produce several different lists, for several different recipients. Thus, the system may transmit lists to several different users after a single triggering event. Information in the list of matches may omit essential identification information for security and/or business purposes. For example, the actual location of a seller or her vehicle may be withheld from the buyer, or the name of the buyer may be withheld from the seller. In most embodiments, the buyer's and seller's price ranges are kept secret, but one embodiment may suggest a target transaction price (calculated, for example, as the midpoint of the overlap between buyer's and seller's ranges). To prevent a party from gaming the system to learn the other party's price range, the target transaction price may be disclosed only once per buyer-seller-vehicle triplet, and perhaps only if the price-range spans are reasonably similar in size.

In addition to the buyer, seller, vehicle and agent information, the service provider receives updates from time to time from these individuals (or even, in some embodiments, from the vehicle itself). An update may supplement or replace earlier-collected information about the buyer, seller, desired vehicle, and so on; but an important sort of update simply provides current information about the geographic location of the reporter (person or vehicle). This information is often available to, and can be efficiently reported by, a software program executing on a mobile device such as a cell phone or tablet computer. (OnStar®—equipped vehicles also have location-determining and communication capabilities, so they can also report into the system, their reports being associated with the seller who owns the vehicle.)

A location report triggers processes at the service provider to compute or re-compute lists of buyer-seller matches. This allows an embodiment to deliver timelier and better-targeted information to the buyer and/or seller. Instead of the traditional lists available to buyers, of all sellers whose contact addresses lie within a static area (such as the circulation region of a newspaper, a Zip code or a particular number of miles from a given location), an embodiment can alert an appropriate person when one participant in the system comes within a configurable range of another participant. Thus, for example, when a buyer happens to be near a seller or her vehicle (and provided that the vehicle is of a type the buyer wants, and that the prices or price ranges are compatible) one or both parties can be notified and offered the opportunity to contact the other. The geographic proximity gives a chance to inspect the vehicle without making a separate appointment or a special trip, so it reduces both sides' transaction costs. Furthermore, by incorporating current geographical information, a buyer or seller who happens to be at some distance from his or her normal environs may learn of a seller or buyer he would not ordinarily be aware of or meet, and be able to complete a transaction faster or more favorably.

Other sorts of reports and data updates may also trigger a re-computation of buyer-seller match lists. For example, if a buyer decides to raise his maximum bid, or if a seller decides to reduce her asking price, a new potential match may arise. The registration of new sellers, new vehicles for sale, and new buyers can also trigger a re-computation and alerts to some participants.

Embodiments of the invention may also accept geographic location reports from friends of the buyer and/or seller. These reports can trigger new match list computations. For example, if a friend of the buyer is near an appropriate vehicle for sale, the buyer can be notified, and can ask his friend to make a preliminary visit to see the vehicle. Or, if a friend of the seller is near the buyer, the seller may decide to contact the buyer with an offer to deliver the vehicle, even though the buyer is at some distance from the seller's normal environs.

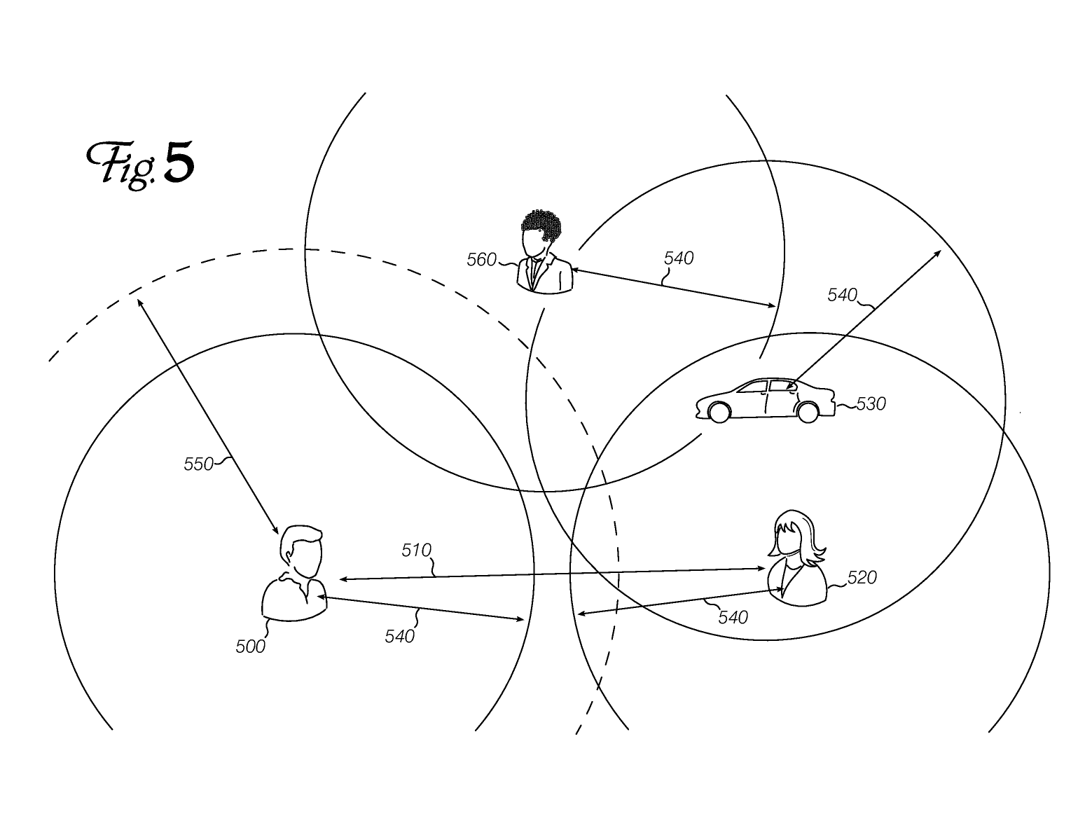

This use of friends of the principals extends the geographic range over which an embodiment may be able to match buyers and sellers, but in a more directed way than simply expanding the radius around the buyer and seller where a potential match is considered. FIG. 5 shows this principle graphically: buyer 500 is at a distance 510 from seller 520 and her vehicle 530. A search for matches within distance 540 would not identify a potential transaction between 500 and 520. Extending the search range to distance 550 or larger would cause the match to appear, but it also vastly extends the area over which other matches occur; this may give too many possibilities and be less useful to the participants.

However, in an embodiment, a friend 560 of the buyer 500 may come within the smaller distance 540 of the seller 520 or her vehicle 530. In that case, buyer 500 may be notified and may consider this potential match (even though it is further away than distance 540 from him) because his friend 560 is there. That is, the transient condition of a friend being near the seller may be enough to overcome the buyer's general preference to avoid a transaction with a party further away than distance 540. (Note that in FIG. 5, friend 560 happens to be within distance 540 of buyer 500. However, this is not essential; an embodiment may detect a match between a buyer and a seller at any distance, so long as a friend [or a friend of a friend] of the buyer is near the seller, or a friend [of a friend] of the seller is near the buyer.)

Extending a buyer's or a seller's range in this manner is especially favorable in a system where the service provider charges participants for increased or broadened access. Say, for example, the provider allows users to search for cars (or for buyers) within a modest radius for free, but charges extra to find additional matches that might exist at an increased distance. A user who involves a member of his social network can obtain an increased effective range for matching, without incurring the additional fee. Thus, an embodiment of the invention can encourage increased participation and offer better-targeted matching by allowing a friend of the buyer or seller to stand in for the principal in triggering and matching operations.

It is appreciated that distances may be measured from person to person, or as radii of circles about each, where overlap of the circles indicates “in range.” Furthermore, distances may be different for each participant (e.g., a buyer may be interested in sellers within 100 miles, while one of the sellers within that range may only be interested in buyers within 50 miles). One can think of a triggering event as one participant moving from outside a boundary about another participant, to inside the boundary about the other participant. (E.g., when the seller moves from 30.5 miles away from the buyer, to 29.5 miles away, and the boundary is at 30 miles.) It is appreciated that inter-participant ranges are transitive, i.e. , if a friend of the buyer is three miles away from the seller's car, then the seller's car is also three miles away from the buyer's friend.

It is preferable for an embodiment to receive and operate on geographic reports with as much accuracy as possible, but the locations may be jittered or obfuscated slightly before disclosing them to another party, to prevent misuse such as “buyers” using the system to find particular types of vehicles to target for theft. Some system participants may direct the system not to disclose their location information at all, so that another participant would learn only that there was a potential match nearby.

The foregoing discussion has provided a general overview of operations of embodiments of the invention to identify potential matches between a buyer and a seller of a vehicle. Embodiments may be limited to detecting such matches and introducing the buyer to the seller, or they may provide additional support to facilitate a transaction.

For example, the service provider may maintain information about dealers and repair facilities, and assist the buyer in obtaining a pre-sale inspection report. It may maintain relationships with financing sources such as banks and credit unions to help a buyer secure funds to purchase the vehicle. Or it may offer insurance, notary and/or registration services to help complete the sale paperwork properly. Many of these are services that are also provided by an auto dealer, so a service provider may be (or may have a close relationship with) a dealer. The information about vehicles for (private-party) sale and vehicles being sought may be of significant value to a dealer. In some embodiments, dealers may be permitted to access some of the information. In some respects, a dealer may treat the vehicles for sale as part of their inventory, but it is inventory for which the dealer need not pay insurance, maintenance and flooring costs, because the vehicles are still in the physical custody and care of the current owner. However, if a customer requests such a vehicle from the dealer, the dealer can contact the seller through an embodiment and attempt to strike a deal. Since the dealer has the customer, and was spared the costs of carrying the vehicle, it can offer both seller and buyer a more favorable deal than if it had to purchase and hold the vehicle until a buyer happened to come along.

Some embodiments may also allow registration by individuals who are not immediately planning to buy or sell a vehicle. They may be “testing the waters” or performing market research to learn how much a desired vehicle is likely to cost, or how long it is likely to take to find one. Such “tire-kicking” (or “market-watching”) users may be converted to buyers or sellers by the appearance of a particularly desired (or attractively priced) vehicle. Such a user may self-identify during registration or during later use of the system. An embodiment can therefore collect information about its users' future buying or selling intentions. This information may be of significant value to other participants in the market. Even though a user may not be ready to buy or sell a car immediately, learning about the market ahead of time can save them of time and money, later. Perhaps the user's vehicle is highly sought after . . . someone might make him an unexpected offer.

When a vehicle of interest to a market-watching potential buyer (or a vehicle like that owned by a market-watching potential seller) is involved in a purchase/sale transaction, the market watcher(s) may also be notified. (In most embodiments, these notifications will not include any identification of the buyer or seller, but may include the approximate location, approximate transaction price, or other non-specific information.)

### Match Computation

When a triggering event causes a computation or re-computation of buyer-seller matches, one can imagine that the system constructs a two-dimensional matrix with every buyer on one axis, and every vehicle on the other axis. Then, for each buyer-vehicle pair, the system computes a match quality metric, indicating how likely it is that the buyer will be interested in the vehicle. Some pairings will be exceedingly unlikely (e.g., the buyer will be too far away from the vehicle, or the vehicle will be the wrong type, or the asking price will be too high). Thus, for pairings below a certain minimum match quality, the system will never notify either buyer or seller. Better-quality matches will be sorted by quality, and some or all of the matches may be reported to the buyer (i.e., vehicles for sale that fit his criteria); or some or all of the matches may be reported to the seller (i.e., buyers who are looking for a vehicle like the one she is selling). The following table lists several criteria that may be combined in a weighted fashion to estimate match quality. An embodiment may use some or all of these criteria, and may add or substitute other criteria to obtain effective match rankings. These criteria are presented in roughly descending order of importance.

| Criterion | Note/Explanation |
|---|---|
| Location | Long-distance matches are not made (however, if an agent |
| | of the buyer or seller, respectively, comes near the seller |
| | or buyer, the match may appear) |
| Use-match | No match if the vehicle does not fit the |
| | buyer's specification or expected use. |
| Price | No match where the seller's desired price range does |
| | not touch or overlap the buyer's target price range. |
| | Greater overlap between price ranges improves match |
| | quality. |
| Condition | The relative importance of these criteria may be ranked |
| Mileage | by the buyer, and will affect the quality of each potential |
| Color | match accordingly. |
| Options | |
| Buyer/Seller | (See [0043] below) |
| Adjustments | |

An embodiment may calculate a simple “match quality” measure for use in comparing and sorting matches as follows: for each parameter entered by buyers and sellers, the parameters' compatibility is ranked from low to high (for example using a five-level integer scale). If all input parameters match one another, a “5” is returned for that parameter. If the seller's vehicle is a year off from the buyer's target, the match number for that parameter is decreased. If the make, model and style match, a “5” is returned for that parameter. This is clone for each of the parameters, and then the average for all the parameter match numbers is returned and rounded to provide a single number that indicates the quality of the vehicle match.

Some embodiments may offer the participants an opportunity to increase the system's quality estimate of a match involving that participant. For example, a seller may provide pictures of her vehicle, submit a verified insurance-claim history showing no accidents, or have her vehicle inspected by a trusted dealer, and submit the inspection report for a potential buyer's review. If a match recalculation identifies a potential match with a buyer, the buyer may consider the availability of this information favorably when reviewing the matches. Similarly, a buyer may provide evidence of financial capability (e.g., a credit score) to reassure a seller that the buyer is legitimately in the market. For both buyers and sellers, the system may provide a way to authenticate the user (i.e., to establish that the user is a particular real individual) or to certify that, for example, a background check of the user did not turn up adverse history such as a bankruptcy or criminal conviction. Such certifications may make parties more willing to consider dealing with each other, or affect the transaction price the buyer will offer (or the seller will accept).

### Post-Transaction Features

A principal function of an embodiment is to identify potential matches between buyers and sellers, and to notify appropriate parties. This alone is a useful service, and an adequate basis for business operations of a service provider. However, in addition to finding matches and (optionally) providing transaction facilitation support (see, e.g., [0037]), an embodiment may also perform follow-up activities, as outlined here.

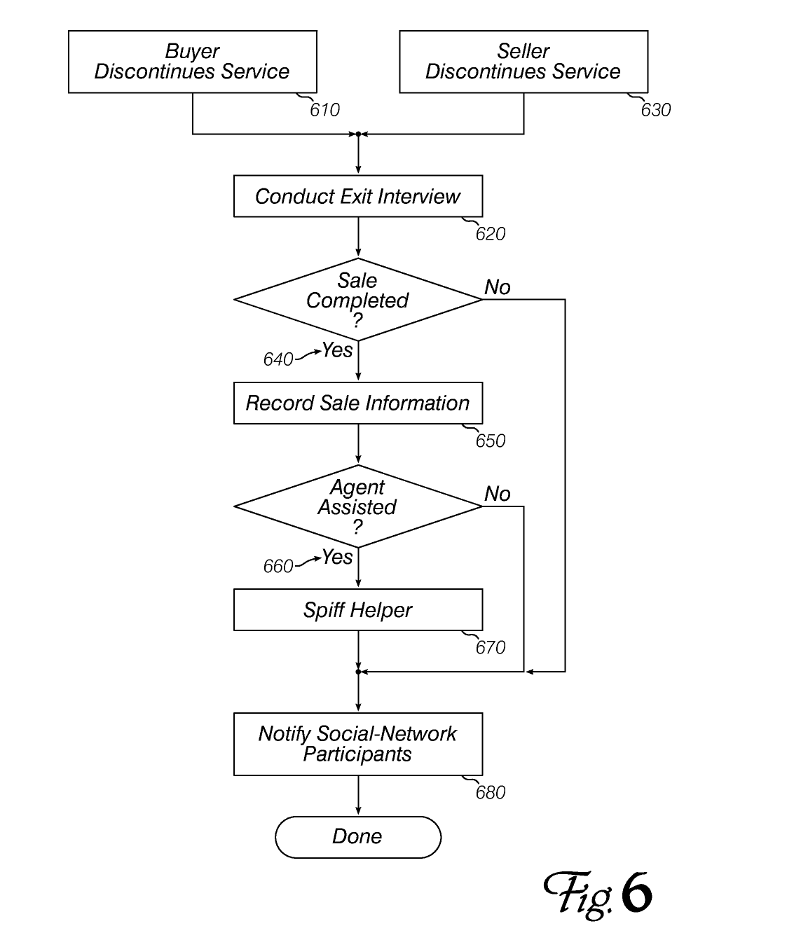

Turning to FIG. 6, when a buyer cancels, removes or disables his search (610), the system automatically performs an “exit interview” (620) to learn whether he purchased a car from another system participant, from a dealer or non-participant, or simply gave up looking. Similarly, if a seller discontinues a for-sale listing (630), the system attempts to learn whether she sold the vehicle to another system participant, to a dealer or non-participant, or decided to keep it. If a sale was completed (640), information such as the price may be recorded (650) to assist in future price-setting activities. If an in-system transaction was completed with the help of an agent of the buyer or seller (660), a “spiff” or “finder's fee” may be provided to reward that person (670). A buyer with a new-to-them vehicle may be offered coupons or other incentives for related services, such as oil changes or other maintenance, tires or insurance. Finally, the buyer or seller may be offered an opportunity to send a message to the friends and other social-network members who helped in the search by installing and running the app on their portable computing devices (680). Or, in some embodiments, the system itself could automatically prepare and send a notification to the social-network members, informing them of the successful transaction and thanking them for their participation.

### Features of Other Preferred Embodiments

System users want to know that they are dealing with someone reputable. An embodiment of the invention may include a way to allow users to opt-in to a background check that helps the person they are dealing with know that the user is who he says he is. A buyer who is unsure about contacting the seller or answering a text message, can check to see if the seller is Certified through the service provider. Becoming Certified is effective to speed up a transaction.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that potential buyer/seller matches can also be made by software and hardware that distribute the functions of embodiments of this invention differently than herein described. Such variations and implementations are understood to be captured according to the following claims.

I claim:

1. A method for fostering interactions between prospective buyers and sellers of used vehicles, comprising:
collecting seller information comprising seller identification information and vehicle-for-sale information from a plurality of sellers;
collecting buyer information comprising buyer identification information and desired-vehicle information from a plurality of buyers; and
upon a triggering event, comparing the vehicle-for-sale information with the desired-vehicle information to produce a list of potential matches, said list relevant to one of the plurality of sellers or one of the plurality of buyers;
sorting the list of potential matches by expected desirability; and
transmitting the list to the one of the plurality of sellers or the one of the plurality of buyers.

2. The method of claim 1, further comprising:
updating the seller information about one of the plurality of sellers to include current geolocation information about the one of the plurality of sellers, and wherein
the triggering event is a determination that one of the plurality of sellers has moved from outside a bounded area associated with one of the plurality of buyers, to inside the bounded area associated with the one of the plurality of buyers.

3. The method of claim 1, further comprising:
updating the buyer information about one of the plurality of buyers to include current geolocation information about the one of the plurality of buyers, and wherein
the triggering event is a determination one of the plurality of buyers has moved from outside a bounded area associated with one of the plurality of sellers, to inside the bounded area associated with the one of the plurality of sellers.

4. The method of claim 1, further comprising:
collecting agent information about an acquaintance of one of the plurality of buyers;
updating the agent information to include current geolocation information about the agent, and wherein
the triggering event is a determination that the agent is within the bounded area associated with the one of the plurality of sellers.

5. The method of claim 1, further comprising:
collecting agent information about an acquaintance of one of the plurality of sellers;
updating the agent information to include current geolocation information about the agent, and wherein
the triggering event is a determination that the agent is within the bounded area associated with the one of the plurality of buyers.

6. The method of claim 1, further comprising:
collecting vehicle information about a current geographic location of the vehicle, and wherein
the triggering event is a determination that the vehicle is near one of the plurality of buyers.

7. The method of claim 1 wherein the list of potential matches omits information essential to complete a sales transaction of a vehicle, the method further comprising:
receiving payment authorization from the one of the plurality of sellers or the one of the plurality of buyers; and
transmitting the essential information to the one of the plurality of sellers or the one of the plurality of buyers after receiving the payment authorization.

8. The method of claim 1 wherein the vehicle-for-sale information comprises a physical location of the vehicle.

9. The method of claim 1 wherein the desired-vehicle information comprises use-match information.

10. The method of claim 9 wherein the use-match information is an intended vehicle use purpose.

11. The method of claim 9 wherein the use-match information is a driving style.

12. The method of claim 9 wherein the use-match information is a towing capacity.

13. The method of claim 1 wherein the vehicle-for-sale information comprises a desired sale-price range and the desired-vehicle information comprises a desired purchase-price range, the method further comprising:
computing a potential price between a lower price of the desired sale-price range and an upper price of the desired purchase price range; and
transmitting the potential price to the one of the plurality of sellers or the one of the plurality of buyers.

14. The method of claim 1, further comprising:
collecting sales information about completed vehicle sales, said sales information comprising sales price;
collecting market-watcher information comprising individual identification information and interested-vehicle information from a plurality of market watchers; and
upon a triggering event, transmitting sales information to one of the plurality of market watchers.

15. A method for assisting a seller in marketing and selling a vehicle, comprising:
collecting information about a seller and a vehicle to be sold, said information comprising a target price of the seller;
selecting a plurality of sales records from a vehicle sales database based on the information about the vehicle to be sold;
providing a price-effectiveness estimate based on the seller's target price and the plurality of sales records;
recording the information about the seller and the vehicle to be sold in a marketing database, and then:
receiving a geolocation estimate of the seller;
searching the marketing database for a suitable buyer information record, wherein a suitability determination includes a comparison of the geolocation estimate of the seller with a geographic fence of a buyer; and
if at least one suitable buyer information record is located, notifying the seller of a count of suitable buyer location information records that were located through the searching operation.

16. The method of claim 15 wherein the suitability determination includes a comparison of the geolocation estimate of the seller with a geographic fence of an acquaintance of a buyer.

17. The method of claim 15 wherein the seller's target price is a target price range comprising a minimum acceptable price and a maximum desired price.

18. The method of claim 17 wherein the suitability determination includes confirming that an acceptable price of the buyer falls between the minimum acceptable price and the maximum desired price of the seller.

19. A non-transitory computer-readable medium containing instructions and data to be transmitted to a computing device, the instructions and data to cause the computing device to perform operations comprising:
obtaining an estimate of a current geographic location of the computing device;
transmitting the estimate to a server with information to enable the server to associate the estimate with a desired vehicle profile;
receiving a reply from the server, said reply comprising a list of filtered and matched vehicles for sale that match the desired vehicle profile and a geographic filter based on the current geographic location; and
displaying the list of filtered and matched vehicles for sale.

20. The computer-readable medium of claim 19, wherein the instructions and data are to be transmitted to a mobile computing device.

21. The computer-readable medium of claim 19 containing additional data and instructions to cause the computing device to perform operations comprising:
querying a user of the computing device when a desired-vehicle profile has been deactivated from the server to learn whether a transaction involving the desired vehicle has occurred;
recording information about the transaction; and
sending a post-transaction message to a member of the user's social network.

22. The computer-readable medium of claim 19, wherein the instructions and data are to be transmitted to and executed by two different, independent computing devices, and wherein:
a first of the two different, independent computing devices is to obtain the estimate and transmit the estimate to the server, and
a second of the two different, independent computing devices is to receive and display the list of filtered and matched vehicles for sale.

23. A method for assisting a buyer to locate a vehicle for sale, comprising:
collecting and storing buyer identification information from a buyer;
collecting and storing desired-vehicle information from the buyer, said desired-vehicle information comprising use-match information describing a type of vehicle and a buyer's target price range comprising a maximum acceptable price and minimum desired price;
selecting a list of vehicles from a database of vehicles for sale, each vehicle of said list of vehicles matching the use-match information and a price of each vehicle of said list compatible with the buyer's target price range; and
sending the list of vehicles to the buyer.

24. The method of claim 23, further comprising:
receiving an indication of a geographic location of the buyer, and wherein
the selecting operation is performed after the receiving operation, said selecting operation further confirming that a location of each vehicle of said list of vehicles is less than a predetermined distance from the geographic location of the buyer.
